(19) United States
(12) Patent Application Publication
(10) Pub. No.: US 2025/0230270 A1
(43) Pub. Date: Jul. 17, 2025

(54) METHOD FOR PRODUCING POLYURETHANE FOAM SHEET AND METHOD FOR PRODUCING SYNTHETIC LEATHER

(71) Applicant: DIC Corporation, Tokyo (JP)

(72) Inventors: Yoshinori Kanagawa, Osaka (JP); Hiroyuki Chijiwa, Takaishi-shi (JP); Masami Takenaka, Takaishi-shi (JP)

(73) Assignee: DIC Corporation, Tokyo (JP)

(21) Appl. No.: 18/850,093

(22) PCT Filed: Jan. 12, 2023
(86) PCT No.: PCT/JP2023/000509

§ 371 Date: Sep. 24, 2024

(30) Foreign Application Priority Data
Apr. 12, 2022 (JP) 2022-065650

(51) Int. Cl. C08G 18/12; C08G 18/20; C08G 18/32; C08G 18/40; C08G 18/48; D06N 3/00; D06N 3/14

(52) U.S. Cl. CPC C08G 18/12; C08G 18/2063; C08G 18/3206; C08G 18/4018; C08G 18/4854; D06N 3/005; D06N 3/146; C08G 2110/0008; C08G 2110/0083

(57) ABSTRACT

A method for producing a polyurethane foam sheet, including applying, in sheet form, a mixture obtained by mixing a moisture-curable polyurethane hot melt resin composition (X) containing a urethane prepolymer (i), which is a reaction product between a polyol (A) and a polyisocyanate (B), with a polyol composition (Y) onto a substrate, and bringing the mixture in the sheet form into contact with water vapor to moisture-foam the mixture. The method for producing a polyurethane foam sheet is characterized in that the polyol (A) contains a polytetramethylene glycol or polycarbonate polyol (a1) and a polyol (a2) having a structure derived from an alkylene oxide adduct of bisphenol A, and the polyol composition (Y) contains an amine catalyst (y1) having a foaming constant (Kw) of 10 or more.

### TECHNICAL FIELD

The present invention provides a method for producing a polyurethane foam sheet and a method for producing a synthetic leather.

### BACKGROUND ART

With the regulations on the use of dimethylformamide (DMF) gaining momentum in Europe, the supply of solvent-free, energy-saving, environmentally responsible resins has been highly desired. In this situation, moisture-curable hot melt urethane compositions, which are free of solvent, are attracting attention and have been widely used in the production of building materials, automotive interior materials, and electrical and electric devices such as refrigerators, smartphones, personal computers, and car navigation systems, for example. In particular, in recent years, for the purposes of improving the impact resistance and texture through the buffering effect, reducing the usage of moisture-curable hot melt urethane compositions, etc., there is an increasing number of cases where a moisture-curable polyurethane hot melt composition is foamed and used as a cured foam.

As such a method for foaming and curing a moisture-curable hot melt urethane composition, a moisture-foaming method, which uses water or water vapor, has been widely studied (see, e.g., PTLs 1 and 2). However, there is a demand for a foam sheet having a better texture.

### CITATION LIST

### Patent Literature

PTL 1: JP2004-115705A
PTL 2: JP2003-306526A

### SUMMARY OF INVENTION

### Technical Problem

The problem to be solved by the invention is to provide a method for producing a polyurethane foam sheet having a good texture.

### Solution to Problem

The invention provides a method for producing a polyurethane foam sheet, including applying, in sheet form, a mixture obtained by mixing a moisture-curable polyurethane hot melt resin composition (X) containing a urethane prepolymer (i), which is a reaction product between a polyol (A) and a polyisocyanate (B), with a polyol composition (Y) onto a substrate, and bringing the mixture in the sheet form into contact with water vapor to moisture-foam the mixture, in which the polyol (A) contains a polytetramethylene glycol or polycarbonate polyol (a1) and a polyol (a2) having a structure derived from an alkylene oxide adduct of bisphenol A, and the polyol composition (Y) contains an amine catalyst (y1) having a foaming constant (Kw) of 10 or more.

In addition, the invention provides a method for producing a synthetic leather having at least a substrate, an adhesive layer, and a skin layer, in which the adhesive layer is obtainable by the method for producing a polyurethane foam sheet described above.

### Advantageous Effects of Invention

According to the method for producing a polyurethane foam sheet of the invention, a polyurethane foam sheet having a good texture can be obtained. In addition, the polyurethane foam sheet also has excellent adhesion, and thus is particularly suitable for use as an adhesive layer for a synthetic leather.

### DESCRIPTION OF EMBODIMENTS

The method for producing a polyurethane foam sheet of the invention is a method for producing a polyurethane foam sheet, including applying, in sheet form, a mixture obtained by mixing a moisture-curable polyurethane hot melt resin composition (X) containing a urethane prepolymer (i), which is a reaction product between a polyol (A) and a polyisocyanate (B), with a polyol composition (Y) onto a substrate, and bringing the mixture in the sheet form into contact with water vapor to moisture-foam the mixture, in which as the polyol (A) and the polyol composition (Y), specific ones are used.

As the urethane prepolymer (i), a reaction product between a polyol (A) and a polyisocyanate (B) can be used.

As the polyol (A), in order to obtain an excellent texture while maintaining excellent adhesion and mechanical strength, it is essential that a polytetramethylene glycol or polycarbonate polyol (a1) and a polyol (a2) having a structure derived from an alkylene oxide adduct of bisphenol A are contained.

As the polycarbonate polyol, for example, a reaction product between a compound having two or more hydroxyl groups and a carbonate ester and/or phosgene can be used.

As the compound having two or more hydroxyl groups, for example, propanediol, butanediol, pentanediol, hexanediol, decanediol, caprolactone, cyclohexanedimethanol, 3-methyl-1,5-pentanediol, neopentyl glycol, isosorbide, and the like can be used. These compounds may be used alone, and it is also possible to use two or more kinds together.

As the carbonate ester, for example, dimethyl carbonate, diethyl carbonate, diphenyl carbonate, ethylene carbonate, propylene carbonate, and the like can be used. These compounds may be used alone, and it is also possible to use two or more kinds together.

For the reason that even better adhesion, mechanical strength, and texture can be obtained, the number average molecular weights of the polytetramethylene glycol and the polycarbonate polyol are preferably 500 to 10,000, and more preferably 700 to 5,000. Incidentally, the number average molecular weight of the polytetramethylene glycol or the polycarbonate polyol refers to a value measured by gel permeation chromatography (GPC).

For the reason that even better adhesion, mechanical strength, and texture can be obtained, the amounts of the polytetramethylene glycol and the polycarbonate polyol used are each preferably 20 to 90 mass %, more preferably 60 to 90 mass %, in the polyol (A).

As the polyol (a2) having a structure derived from an alkylene oxide adduct of bisphenol A, for example, a polyether polyol (a2-1) having a structure derived from an alkylene oxide adduct of bisphenol A, a polyether polyol (a2-2) having a structure derived from an alkylene oxide adduct of bisphenol A, and the like can be used. These polyols may be used alone, and it is also possible to use two or more kinds together. It is preferable that each is used alone.

As the polyether polyol (a2-1) having a structure derived from an alkylene oxide adduct of bisphenol A, for example, an alkylene oxide adduct of bisphenol A can be used. As the alkylene oxide, for example, ethylene oxide, propylene oxide, butylene oxide, and the like can be used, and the number of moles of the alkylene oxide added is preferably 1 to 10, and more preferably 2 to 8.

For the reason that even better adhesion, mechanical strength, and texture can be obtained, the number average molecular weight of the polyether polyol (a2-1) is preferably 200 to 3,000, and more preferably 400 to 2,000. Incidentally, the number average molecular weight of the polyether polyol (a2-1) refers to a value measured by gel permeation chromatography (GPC).

As the polyester polyol (a2-2) having a structure derived from an alkylene oxide adduct of bisphenol A, for example, a reaction product between a hydroxyl group-containing compound containing an alkylene oxide adduct of bisphenol A and an aliphatic polybasic acid and/or aromatic polybasic acid can be used.

As the hydroxyl group-containing compound, for example, aliphatic compounds such as ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, diethylene glycol, triethylene glycol, triethylene glycol, tetraethylene glycol, neopentyl glycol, 1,2-butanediol, 1,3-butanediol, 2-methyl-1,3-propanediol, 2,2-diethyl-1,3-propanediol, 3-methyl-1,5-pentanediol, 2-ethyl-2-butyl-1,3-propanediol, 2-methyl-1,8-octanediol, 2,4-diethyl-1,5-pentanediol, trimethylolethane, trimethylolpropane, and pentaerythritol; alicyclic compounds such as cyclopentanediol, cyclohexanediol, cyclohexanedimethanol, hydrogenated bisphenol A, and bisphenol F; and the like can be used. These compounds may be used alone, and it is also possible to use two or more kinds together.

The amount of the alkylene oxide adduct of bisphenol A used in the hydroxyl group-containing compound is preferably 80 mass % or more, and more preferably 90 mass % or more.

As the aliphatic polybasic acid, succinic acid, adipic acid, pimelic acid, suberic acid, azelaic acid, sebacic acid, decanedioic acid, dodecanedioic acid, eicosanedioic acid, citraconic acid, itaconic acid, citraconic anhydride, itaconic anhydride, and the like can be used. These compounds may be used alone, and it is also possible to use two or more kinds together.

As the aromatic polybasic acid, for example, phthalic acid, isophthalic acid, terephthalic acid, phthalic anhydride, and the like can be used. As other polybasic acids, for example, oxalic acid, malonic acid, succinic acid, adipic acid, sebacic acid, azelaic acid, 1,12-dodecanedicarboxylic acid, and the like can be used. These compounds may be used alone, and it is also possible to use two or more kinds together. For the reason that even better adhesion, mechanical strength, and texture can be obtained, as the aromatic polybasic acid, it is preferable to use at least one compound selected from the group consisting of phthalic acid, isophthalic acid, terephthalic acid, and phthalic anhydride.

For the reason that even better adhesion, mechanical strength, and texture can be obtained, the number average molecular weight of the polyester polyol (a2-2) is preferably 500 to 5,000, and more preferably 1,000 to 3,000. Incidentally, the number average molecular weight of the polyester polyol (a2-2) refers to a value measured by gel permeation chromatography (GPC).

For the reason that even better adhesion, mechanical strength, and texture can be obtained, the amount of the polyol (a2) used is preferably 10 to 80 mass %, more preferably 10 to 40 mass %, in the polyol (A).

As the polyol (A), in addition to the components (a1) and (a2) described above, other polyols may also be used together if necessary. As the other polyols, for example, polyether polyols, polyester polyols, and polycarbonate polyols other than the components (a1) and (a2), etc., can be used. These polyols may be used alone, and it is also possible to use two or more kinds together.

As the polyisocyanate (B), for example, aromatic polyisocyanates such as polymethylene polyphenyl polyisocyanate, diphenylmethane diisocyanate, polymeric diphenylmethane diisocyanate, carbodiimide-modified diphenylmethane diisocyanate, xylylene diisocyanate, phenylene diisocyanate, tolylene diisocyanate, and naphthalene diisocyanate; aliphatic or alicyclic polyisocyanates such as hexamethylene diisocyanate, lysine diisocyanate, cyclohexane diisocyanate, isophorone diisocyanate, dicyclohexylmethane diisocyanate, and tetramethylxylylene diisocyanate; and the like can be used. These polyisocyanates may be used alone, and it is also possible to use two or more kinds together. Among them, for the reason that good adhesion, reactivity, and mechanical properties can be obtained, aromatic polyisocyanates are preferable, and diphenylmethane diisocyanate is more preferable.

The urethane prepolymer (i) can be produced by a method in which, for example, the polyol (A) is added dropwise into a reaction vessel containing the polyisocyanate (B) and then heated to allow them to react under conditions where the isocyanate groups of the polyisocyanate (B) are in excess of the hydroxyl groups of the polyol (A).

In the production of the urethane prepolymer (i), in terms of the adhesion, texture, and mechanical strength, the equivalent ratio ([NCO/OH]) of the isocyanate groups of the polyisocyanate (B) to the hydroxyl groups of the polyol (A) is preferably 1.1 to 5.0, and more preferably 1.5 to 3.5.

In terms of the adhesion, texture, and mechanical strength, the isocyanate group content (hereinafter abbreviated as “NCO %)” in the urethane prepolymer (i) is preferably 1.1 to 5.0, and more preferably 1.5 to 3.5 mass %. Incidentally, the isocyanate group content in the urethane prepolymer (i) refers to a value measured by potentiometric titration in accordance with JISK1603-1:2007.

The moisture-curable polyurethane hot-melt composition (X) used in the invention contains the urethane prepolymer (i) as an essential component, but may also contain other additives if necessary.

As the other additives, in addition to the polyol composition (Y) described below, for example, silane coupling agents, thixotropic agents, antioxidants, plasticizers, fillers, dyes, pigments, waxes, and the like can be used. These additives may be used alone, and it is also possible to use two or more kinds together.

When the polyol composition (Y) is mixed with the moisture-curable polyurethane hot melt composition, the isocyanate groups of the urethane prepolymer (i) reacts with the polyol in the polyol composition (Y). This can moderately increase the viscosity to fix bubbles in the polyurethane foam sheet resulting from moisture foaming, and can also contribute to the flexibility, mechanical strength, and durability of the resulting polyurethane foam sheet.

As the polyol, for example, ethylene glycol, 1,2-propylene glycol, 1,3-propylene glycol, 1,3-butanediol, 1,4-butanediol, 2,2-dimethyl-1,3-propanediol, 1,6-hexanediol, 3-methyl-1,5-pentanediol, 1,8-octanediol, diethylene glycol, triethylene glycol, dipropylene glycol, tripropylene glycol, cyclohexane-1,4-diol, cyclohexane-1,4-dimethanol, and the like can be used. These compounds may be used alone, and it is also possible to use two or more kinds together.

The content of the polyol in the polyol composition (Y) is preferably 0.1 to 10.0 mass %, and more preferably 0.5 to 5.0 mass %.

In the invention, in order to obtain an excellent texture, it is essential that the polyol composition (Y) contains an amine catalyst (y1) having a foaming constant (Kw) of 10 or more. As a result of using the specific amine catalyst (y1), the reaction between the isocyanate groups of the urethane prepolymer (i) and water during moisture foaming can be accelerated. Thus, large cells can be formed, and the temperature and humidity during moisture foaming can be set at milder conditions than before, making it possible to obtain an excellent texture.

In the invention, the foaming constant (Kw) of an amine catalyst (y1) refers to the catalytic activity constant (L²/(wq·mol·hr)) of toluene diisocyanate (TDI) and water. Specifically, JP2019-85513A, JP2009-14981A, and the like can be referenced.

As the specific amine catalyst (y1), for example, N,N,N′,N″-pentamethyldiethylenetriamine (PMDETA, Kw=159), N,N,N′,N″,N″-pentamethylethylenepropylenetriamine (PMEPTA, Kw=21.5), N,N,N′,N″,N″-pentamethyldipropylenetetraamine (PMDPTA, Kw=11.6), 1,1,4,7,10,10-hexamethyltriethylenetetramine (HMTETA, Kw=84.8), bis(2-dimethylaminoethyl) ether (DMAEE, Kw=25.5), N,N,N′-trimethylaminoethylethanolamine (TMAEEA, Kw=43.4), bis(2-dimethylaminoethyl) ether (BDMEE, Kw=117), 1,4-diazabicyclo[2.2.2]octane=triethylenediamine (TEDA, Kw=14.5), and the like can be used. These catalysts may be used alone, and it is also possible to use two or more kinds together. Among them, for the reason that an even better texture can be obtained, it is preferable to use 1,4-diazabicyclo[2.2.2]octane-triethylenediamine together with another amine catalyst.

In the case where 1,4-diazabicyclo[2.2.2]octane-triethylenediamine is used together with another amine catalyst, for the reason that an even better texture can be obtained, their mass ratio is preferably 1/1 to 1/10, and more preferably 1/1 to 1/5.

The amount of the amine catalyst (y1) used is preferably 1.0 to 20 mass %, more preferably 1.0 to 10 mass %, in the polyol composition (Y).

The polyol composition (Y) may contain other additives in addition to the amine catalyst (y1). As the other additives, for example, catalysts other than the above (y1), foam stabilizers, flame retardants, antistatic agents, fillers, conductive agents, moisture absorbents, inert gases, silane coupling agents, thixotropic agents, tackifiers, waxes, plasticizers, heat stabilizers, light stabilizers, pigments, hydrolysis inhibitors, and the like can be used alone or as a combination of two or more kinds. These additives may be used alone, and may be also used two or more kinds together.

The amount of the polyol composition (Y) used is preferably 1.0 to 50 parts by mass, more preferably 1.0 to 35 parts by mass, per 100 parts by mass of the moisture-curable polyurethane hot melt resin composition (X).

Next, the method for producing a polyurethane foam sheet of the invention will be described.

The method for producing a polyurethane foam sheet of the invention includes a step of applying, in sheet form, a mixture obtained by mixing the moisture-curable polyurethane hot melt resin composition (X), which has been heated and melted at 70 to 150° C., for example, with the polyol composition (Y) onto a substrate, and bringing the mixture in the sheet form into contact with water vapor to moisture-foam the mixture.

As a method for mixing the moisture-curable polyurethane hot melt resin composition (X) and the polyol composition (Y), for example, a method using a high-speed mixing head or a disperser can be mentioned.

As a method for applying the mixture in sheet form onto a substrate such as a release paper, for example, a method using a roll coater, a spray coater, a T-die coater, a knife coater, or the like can be mentioned. As the thickness of the mixture applied in sheet form, for example, 50 to 500 μm can be mentioned.

The obtained sheet-form mixture is brought into contact with water vapor to cause moisture foaming. The technical term “moisture foaming” used in the invention means that water contained in water vapor is used as a blowing agent, and the isocyanate groups of the urethane prepolymer (i) used in the invention react with the water to generate a carbon dioxide gas, thereby causing foaming.

As the conditions for making contact with water vapor, the following conditions can be mentioned, for example. The ambient temperature on the surface of the sheet-form mixture is set at 20 to 120° C., preferably less than 80° C., and more preferably 20 to 35° C., for example, the ambient humidity on the surface of the sheet-form mixture is set at 50% or more, preferably 60% or more and less than 95%, and more preferably 60 to 85%, for example, and the humidification time is set at 0.5 seconds to 10 minutes.

In addition, methods for making contact with water vapor include a method using a humidification chamber, in which the conditions of the ambient temperature and ambient humidity on the mixture surface and the humidification time can be kept constant, a water vapor atomizer, or the like. It is more preferable to use an apparatus that generates saturated water vapor because, as a result, it is less likely to happen that water vapor cools and turns into water droplets during the production line circulation. In addition, in order to further improve the polyurethane foam sheet thickness accuracy, it is preferable to use a pressure belt press, a nip roll, a flat press, or the like together after the humidification treatment.

After making contact with water vapor, the mixture may be aged, for example, at a temperature of 20 to 80° C. and a relative humidity of 50 to 90% for 0.5 to 3 days.

As above, according to the method for producing a polyurethane foam sheet of the invention, a polyurethane foam sheet having a good texture can be obtained. In addition, the polyurethane foam sheet also has excellent adhesion, and thus is particularly suitable for use as an adhesive layer for a synthetic leather.

Next, the method for producing a synthetic leather of the invention will be described.

The synthetic leather has at least a substrate, an adhesive layer, and a skin layer, and, as the adhesive layer, one obtained by the method for producing a polyurethane foam sheet described above can be mentioned.

As the substrate, for example, fiber substrates such as nonwoven fabrics, woven fabrics, and knitted fabrics made of polyester fibers, polyethylene fibers, nylon fibers, acrylic fibers, polyurethane fibers, acetate fibers, rayon fibers, polylactic acid fibers, cotton, hemp, silk, wool, glass fibers, carbon fibers, blended fibers thereof, and the like; the above nonwoven fabrics, impregnated with a resin such as a polyurethane resin; the above nonwoven fabrics, further provided with a porous layer; and thermoplastic polyurethane (TPU) and like resin substrates, as well as genuine leather, split leather, and the like, can be used.

As materials for forming the skin layer, for example, water-based urethane resins, solvent-based urethane resins, solventless urethane resins, water-based acrylic resins, solvent-based acrylic resins, solventless acrylic resins, solvent-based silicone resins, water-based silicone resins, solventless silicone resins, vinyl chloride resins, thermoplastic polyurethane resins, thermoplastic polyester resins, thermoplastic amide resins, thermoplastic polyolefin resins, and the like can be used. These materials may be used alone, and it is also possible to use two or more kinds together.

As a method for producing the synthetic leather, for example, a method in which a mixture obtained by mixing the moisture-curable polyurethane hot melt resin composition (X) with the polyol composition (Y) is applied in sheet form onto a skin layer formed on a release paper, then the mixture in the sheet form is brought into contact with water vapor to moisture-foam the mixture as described above, and the resulting foam sheet, as an adhesive layer, is attached to the substrate, can be mentioned.

If necessary, a surface treatment layer (top coat layer) may be provided on the skin layer.

### EXAMPLES

Hereinafter, the invention will be described in more detail using examples.

### [Synthesis Example 1] Synthesis of Urethane Prepolymer (i-1)

In a 1-liter 4-necked flask, 70 parts by mass of polytetramethylene glycol (number average molecular weight: 2,000, hereinafter abbreviated as “PTMG”) and 30 parts by mass of a polyether polyol with 6 mol of propylene oxide added to bisphenol A (number average molecular weight: 510, hereinafter abbreviated as “BisA6PO”) were heated at 100° C. under reduced pressure and dehydrated to a moisture content of 0.05 mass %.

Next, to the mixture of PTMG and BisA6PO cooled to 60° C., 37.0 parts by mass of 4,4′-diphenylmethane diisocyanate (hereinafter abbreviated as “MDI”) was added, then heated to 100° C., and allowed to react for 3 hours until the isocyanate group content became constant, thereby giving an isocyanate group-containing urethane prepolymer (i-1). The melt viscosity of the urethane prepolymer (i-1) at 120° C. was 1,800 mPa·s, and the NCO % was 3.3 mass %.

### [Synthesis Examples 2 to 4, Comparative Synthesis Examples 1 and 2] Synthesis of Urethane Prepolymers (i-2) to (i-4) and (iR-1) and (iR-2)

Each urethane prepolymer was obtained in the same manner as in Synthesis Example 1, except for using the polyols and polyisocyanates shown in Table 1.

TABLE 1

| | | | | | Comparative | Comparative |
|---|---|---|---|---|---|---|
| | Synthesis | Synthesis | Synthesis | Synthesis | Synthesis | Synthesis |
| | Example 1 | Example 2 | Example 3 | Example 4 | Example 1 | Example 2 |
| | (i-1) | (i-2) | (i-3) | (i-4) | (iR-1) | (iR-1) |
| Polyol (A) | | | | | | |
| PTMG (parts by mass) | 70 | 70 | | | 70 | |
| PC (parts by mass) | | | 80 | 80 | | 80 |
| BisA6PO (parts by mass) | 30 | | 20 | | | |
| PEs (1) (parts by mass) | | 30 | | 20 | | |
| PEs (R1) (parts by mass) | | | | | 30 | 20 |
| Polyisocyanate (B) | | | | | | |
| MDI (parts by mass) | 37 | 25 | 33 | 25 | 25 | 25 |
| NCO % (mass %) | 3.3 | 3.3 | 3.3 | 3.3 | 3.3 | 3.3 |
| Melt viscosity at | 1800 | 1500 | 1800 | 1600 | 1300 | 1500 |
| 120° C. (mPa · s) | | | | | | |

Incidentally, the abbreviations in Table 1 represent the following compounds.
“PC”: Polycarbonate polyol (“NIPPORAN 980R” manufactured by Nippon Polyurethane Co., Ltd., number average molecular weight: 2,000)
“PEs (1)”: Polyester polyol (reaction product of BisA6PO, sebacic acid, and isophthalic acid, number average molecular weight: 2,000)
“PEs (R1)”: Polyester polyol (reaction product of 1,6-hexanediol and adipic acid, number average molecular weight: 2,000)

### [Method for Measuring Number Average Molecular Weight]

The number average molecular weight of each polyol used in synthesis examples, etc., refers to a value measured by gel permeation chromatography (GPC) under the following conditions.
Measuring apparatus: High-performance GPC apparatus (“HLC-8220GPC” manufactured by Tosoh Corporation)
Column: The following columns manufactured by Tosoh Corporation connected in series were used.
   “TSKgel G5000” (7.8 mm I.D.×30 cm)×1
   “TSKgel G4000” (7.8 mm I.D.×30 cm)×1
   “TSKgel G3000” (7.8 mm I.D.×30 cm)×1
   “TSKgel G2000” (7.8 mm I.D.×30 cm)×1
Detector: RI (differential refractometer)
Column temperature: 40° C.
Eluent: Tetrahydrofuran (THF)
Flow rate: 1.0 mL/min
Injection volume: 100 μL (tetrahydrofuran solution having a sample concentration of 0.4 mass %)
Standard sample: Calibration curves were drawn using the following standard polystyrenes.

### (Standard Polystyrene)

“TSKgel Standard Polystyrene A-500” manufactured by Tosoh Corporation
“TSKgel Standard Polystyrene A-1000” manufactured by Tosoh Corporation
“TSKgel Standard Polystyrene A-2500” manufactured by Tosoh Corporation
“TSKgel Standard Polystyrene A-5000” manufactured by Tosoh Corporation
“TSKgel Standard Polystyrene F-1” manufactured by Tosoh Corporation
“TSKgel Standard Polystyrene F-2” manufactured by Tosoh Corporation
“TSKgel Standard Polystyrene F-4” manufactured by Tosoh Corporation
“TSKgel Standard Polystyrene F-10” manufactured by Tosoh Corporation
“TSKgel Standard Polystyrene F-20” manufactured by Tosoh Corporation
“TSKgel Standard Polystyrene F-40” manufactured by Tosoh Corporation
“TSKgel Standard Polystyrene F-80” manufactured by Tosoh Corporation
“TSKgel Standard Polystyrene F-128” manufactured by Tosoh Corporation
“TSKgel Standard Polystyrene F-288” manufactured by Tosoh Corporation
“TSKgel Standard Polystyrene F-550” manufactured by Tosoh Corporation

### [Example 1] Preparation of Polyurethane Foam Sheet

The urethane prepolymer (i-1) obtained in Synthesis Example 1 was heated and melted at 120° C., and 100 parts by mass of this urethane prepolymer (i-1) was mixed with 2.0 parts by mass of 1,4-butanediol (hereinafter abbreviated as “14BG”), 0.15 parts by mass of PMDETA, 0.05 parts by mass of dipropylene glycol (hereinafter abbreviated as “DPG”), 0.1 parts by mass of TEDA, and 1.0 part by mass of a silicon foam stabilizer (“SF-2962” manufactured by Dow Corning Corporation, hereinafter abbreviated as “SF2962”). Using a homodisper, 3.3 parts by mass of the thus-prepared polyol composition was stirred and mixed at 6,000 rpm for 20 seconds, and then immediately applied using an applicator onto a release paper (“DK-100” manufactured by Lintec Corporation) to a thickness of 200 μm. A 50-μm-thick polyethylene film was attached thereto, then humidified with water vapor for 1 minute in an atmosphere at 30° C. and a humidity of 80%, and allowed to stand for 1 day in an environment at a temperature of 23° C. and a humidity of 65%, thereby giving a polyurethane foam sheet.

### Examples 2 to 6, Comparative Examples 1 to 3

Polyurethane foam sheets were obtained in the same manner as in Example 1, except that the kinds and amounts of urethane prepolymer (i) and polyol composition (Y) used were changed as shown in Tables 2 and 3.

TABLE 2

| | | Example 1 | Example 2 | Example 3 | Example 4 | Example 5 |
|---|---|---|---|---|---|---|
| Urethane Prepolymer (i) | Kind | (i-1) | (i-2) | (i-3) | (i-4) | (i-2) |
| | Amount Incorporated (parts by mass) | 100 | 100 | 100 | 100 | 100 |
| Polyol Composition (Y) | 14BG (parts by mass) | 2 | 2 | 2 | 2 | 2 |
| | SF2962 (parts by mass) | 1 | 1 | 1 | 1 | 1 |
| | PMDETA (parts by mass) Kw = 159 | 0.15 | 0.15 | 0.15 | 0.15 | |
| | HMTETA (parts by mass) Kw = 84.8 | | | | | 0.15 |
| | PMDPTA (parts by mass) Kw = 11.6 | | | | | |
| | DMCHA (parts by mass) Kw = 8.3 | | | | | |
| | TEDA (parts by mass) Kw = 14.5 | 0.1 | 0.1 | 0.1 | 0.1 | 0.1 |
| | DPG (parts by mass) | 0.05 | 0.05 | 0.05 | 0.05 | 0.05 |
| | (B) Foam Formulation, | 3.3 | 3.3 | 3.3 | 3.3 | 3.3 |
| | Total (parts by mass) | | | | | |

| | | | | | |
|---|---|---|---|---|---|
| Applied Evaluation of Foam Sheet: | | | | | |
| Thickness upon mixture application (μm) | 200 | 200 | 200 | 200 | 200 |
| Foam thickness after humidification curing (μm) | 430 | 450 | 420 | 430 | 430 |
| Evaluation of bubble collapse after humidification curing | A | A | A | A | A |
| Evaluation of texture | 1 | 1 | 1 | 1 | 1 |
| Tensile Characteristics of Foam Sheet: | | | | | |
| 100% M (MPa) | 2 | 1.8 | 1.5 | 1.3 | 2 |
| Stress at break (MPa) | 12 | 10 | 12 | 10 | 12 |
| Elongation at break (%) | 550 | 580 | 530 | 550 | 560 |

TABLE 3

| | | | Comparative | Comparative | Comparative |
|---|---|---|---|---|---|
| | | Example 6 | Example 1 | Example 2 | Example 3 |
| Urethane Prepolymer (i) | Kind | (i-2) | (iR-1) | (iR-2) | (i-1) |
| | Amount Incorporated (parts by mass) | 100 | 100 | 100 | 100 |
| Polyol Composition (Y) | 14BG (parts by mass) | 2 | 0.5 | 0.5 | |
| | SF2962 (parts by mass) | 1 | 0.1 | 0.1 | |
| | PMDETA (parts by mass) Kw = 159 | | | | |
| | HMTETA (parts by mass) Kw = 84.8 | | | | |
| | PMDPTA (parts by mass) Kw = 11.6 | 0.15 | | | |
| | DMCHA (parts by mass) Kw = 8.3 | | 0.1 | 0.1 | |
| | TEDA (parts by mass) Kw = 14.5 | 0.1 | | | |
| | DPG (parts by mass) | 0.05 | | | |
| | (B) Foam Formulation, | 3.3 | 3.15 | 3.15 | 0 |
| | Total (parts by mass) | | | | |

| | | | | |
|---|---|---|---|---|
| Applied Evaluation of Foam Sheet: | | | | |
| Thickness upon mixture application (μm) | 200 | 200 | 200 | 200 |
| Foam thickness after humidification curing (μm) | 410 | 350 | 330 | 220 |
| Evaluation of bubble collapse after humidification curing | A | B | B | C |
| Evaluation of texture | 1 | 2 | 2 | 3 |
| Tensile Characteristics of Foam Sheet: | | | | |
| 100% M (MPa) | 2.2 | 2.5 | 3 | 3.5 |
| Stress at break (MPa) | 15 | 8 | 12 | 43 |
| Elongation at break (%) | 530 | 715 | 650 | 780 |

Incidentally, an abbreviation in Tables 2 to 5 represents the following compound.
“DMCHA”: N,N-dimethylcyclohexylamine (Kw=8.3)
   [Method for Measuring Bubble Collapse Against Stress after Humidification Curing]

Each of the polyurethane foam sheets obtained in the examples and comparative examples was, after humidification and curing, allowed to stand for 30 minutes at an ambient temperature of 23° C. and a relative humidity of 65%. Subsequently, a load of 1 kg was applied to a 5 cm×5 cm square area for 2 hours, and, after the load was removed, the collapse of bubbles against stress was visually evaluated as follows.
A: Bubbles of the foam were maintained with no change in appearance.
B: Bubbles of the foam partially collapsed, resulting in changes in appearance.
C: Bubbles of the foam entirely collapsed, resulting in changes in appearance.

### [Evaluation Method for Texture of Polyurethane Foam Sheet]

Each of the polyurethane foam sheets obtained in the examples and comparative examples was bent by hand, etc., and the texture was thus evaluated by touch on the following five-point scale.
1: Very soft and hard.
2: A little soft.
3: Soft.
4: A little hard.
5: Hard.

### [Measurement Method for Tensile Characteristics of Polyurethane Foam Sheet]

Each of the polyurethane foam sheets obtained in the examples and comparative examples was cut into a 5-mm-wide test piece, and, using Tensilon (manufactured by Shimadzu Corporation, H·S=300 mm/min; “H·S” stands for “head speed.” The same applies hereinafter), and the tensile characteristics (100% modulus (hereinafter abbreviated as “100% M”) (MPa), stress at break (MPa), and elongation at break (%)) were measured in accordance with JIS K7311:1995.

### [Synthesis Example 5] Preparation Method for Skin Film (1)

“HYDRAN WLS-230” (manufactured by DIC Corporation), a water-based urethane resin for a skin layer for synthetic leathers, was mixed with a pigment (DILAC-BLACK HS6001 (manufactured by DIC Corporation) and 0.3 parts by mass of a defoamer (“TEGO Foamex 800” manufactured by EVONIK INDUSTRIES AG EVONIK Corporation), and, using a comma coater, uniformly applied onto a release paper (“EV-130TPD” manufactured by LINTEC Corporation) to a coating weight of 100 g/m² (wet), followed by drying at 70° C. for 2 minutes and then drying at 120° C. for 2 minutes, thereby preparing a skin film (1) having a thickness of 30 μm.

### [Synthesis Example 6] Preparation Method for Skin Film (2)

“HYDRAN WLS-250” (manufactured by DIC Corporation), a water-based urethane resin for a skin layer for synthetic leathers, was mixed with a pigment (DILAC-BLACK HS6001 (manufactured by DIC Corporation) and 0.3 parts by mass of a defoamer (“TEGO Foamex 800” manufactured by EVONIK INDUSTRIES AG), and, using a comma coater, uniformly applied onto a release paper (“EV-130TPD” manufactured by LINTEC Corporation) to a coating weight of 100 g/m² (wet), followed by drying at 70° C. for 2 minutes and then drying at 120° C. for 2 minutes, thereby preparing a skin film (2) having a thickness of 30 μm.

### [Example 7] Preparation of Synthetic Leather

The urethane prepolymer (i-1) obtained in Synthesis Example 1 was heated and melted at 120° C., and 100 parts by mass of this urethane prepolymer (i-1) was mixed with 2.0 parts by mass of 14BG, 0.15 parts by mass of PMDETA, 0.05 parts by mass of DPG, 0.1 parts by mass of TEDA, and 1.0 part by mass of SF2962. Using a homodisper, 3.3 parts by mass of the thus-prepared polyol composition was stirred and mixed at 6,000 rpm for 20 seconds, and then immediately applied using an applicator onto the skin film (1) obtained in Synthesis Example 5 to a thickness of 200 μm. A rayon napped fabric fabric was attached thereto, then humidified with water vapor for 1 minute in an atmosphere at 30° C. and a humidity of 80%, and allowed to stand for 1 day in an environment at a temperature of 23° C. and a humidity of 65%, thereby giving a synthetic leather.

### Examples 8 to 12, Comparative Examples 4 to 6

Polyurethane foam sheets were obtained in the same manner as in Example 1, except that the kinds and amounts of urethane prepolymer (i) and polyol composition (Y) used and the kind of skin film used were changed as shown in Tables 4 and 5.

TABLE 4

| | | Example 7 | Example 8 | Example 9 | Example 10 | Example 11 |
|---|---|---|---|---|---|---|
| Urethane Prepolymer (i) | Kind | (i-1) | (i-2) | (i-3) | (i-4) | (i-2) |
| | Amount Incorporated (parts by mass) | 100 | 100 | 100 | 100 | 100 |
| Polyol Composition (Y) | 14BG (parts by mass) | 2 | 2 | 2 | 2 | 2 |
| | SF2962 (parts by mass) | 1 | 1 | 1 | 1 | 1 |
| | PMDETA (parts by mass) Kw = 159 | 0.15 | 0.15 | 0.15 | 0.15 | |
| | HMTETA (parts by mass) Kw = 84.8 | | | | | 0.15 |
| | PMDPTA (parts by mass) Kw = 11.6 | | | | | |
| | DMCHA (parts by mass) Kw = 8.3 | | | | | |
| | TEDA (parts by mass) Kw = 14.5 | 0.1 | 0.1 | 0.1 | 0.1 | 0.1 |
| | DPG (parts by mass) | 0.05 | 0.05 | 0.05 | 0.05 | 0.05 |
| | (B) Foam Formulation, | 3.3 | 3.3 | 3.3 | 3.3 | 3.3 |
| | Total (parts by mass) | | | | | |

| | | | | | |
|---|---|---|---|---|---|
| Applied Evaluation of Synthetic Leather: | | | | | |
| Thickness upon mixture application (μm) | 200 | 200 | 200 | 200 | 200 |
| Foam layer thickness after humidification curing (μm) | 390 | 400 | 370 | 380 | 370 |
| Peel strength (kgf/inch) | 3.8 | 3.57 | 3.8 | 4 | 4.2 |
| Evaluation of texture (touch) | 1 | 1 | 1 | 1 | 1 |
| Evaluation of texture (tester, mm) | 4.35 | 4.45 | 4.3 | 4.5 | 4.3 |

TABLE 5

| | | | Comparative | Comparative | Comparative |
|---|---|---|---|---|---|
| | | Example 12 | Example 4 | Example 5 | Example 6 |
| Urethane Prepolymer (i) | Kind | (i-2) | (iR-1) | (iR-2) | (i-1) |
| | Amount Incorporated (parts by mass) | 100 | 100 | 100 | 100 |
| Polyol Composition (Y) | 14BG (parts by mass) | 2 | 0.5 | 0.5 | |
| | SF2962 (parts by mass) | 1 | 0.1 | 0.1 | |
| | PMDETA (parts by mass) Kw = 159 | | | | |
| | HMTETA (parts by mass) Kw = 84.8 | | | | |
| | PMDPTA (parts by mass) Kw = 11.6 | 0.15 | | | |
| | DMCHA (parts by mass) Kw = 8.3 | | 0.1 | 0.1 | |
| | TEDA (parts by mass) Kw = 14.5 | 0.1 | | | |
| | DPG (parts by mass) | 0.05 | | | |
| | (B) Foam Formulation, | 3.3 | 3.15 | 3.15 | 0 |
| | Total (parts by mass) | | | | |

| | | | | |
|---|---|---|---|---|
| Applied Evaluation of Synthetic Leather: | | | | |
| Thickness upon mixture application (μm) | 200 | 200 | 200 | 200 |
| Foam thickness after humidification curing (μm) | 350 | 280 | 250 | 200 |
| Peel strength (kgf/inch) | 4.4 | 4.5 | 4.7 | 4.8 |
| Evaluation of texture (touch) | 1 | 2 | 2 | 3 |
| Evaluation of texture (tester, mm) | 4.1 | 4 | 3.95 | 3.6 |

### [Evaluation Method for Peeling Strength of Synthetic Leather]

Onto the skin film of each of the synthetic leathers obtained in examples and comparative examples, a fabric hot melt tape was heat-pressed at 130° C. for 5 seconds. Subsequently, using Tensilon (manufactured by Shimadzu Corporation), the peel strength (kgf/inch) was measured at a head speed of 200 mm/min in accordance with JIS K6854-2:1999.

### [Measurement Method for Texture of Synthetic Leather (1)]

The texture of each of the synthetic leathers obtained in examples and comparative examples was evaluated by touch on the following five-point scale.
1: Very soft and hard.
2: A little soft.
3: Soft.
4: A little hard.
5: Hard.

### [Measurement Method for Texture of Synthetic Leather (2)]

The degree of texture of each synthetic leather was measured using a softness tester (Leather Softness Measuring Apparatus “ST300” manufactured by MSA Engineering Systems). Specifically, after a predetermined ring 15 mm in diameter was placed in a lower holder of the apparatus, each synthetic leather was set in the lower holder. A metal pin (5 mm in diameter) fixed to an upper lever was pressed down toward the synthetic leather, and the numerical value when the upper lever was locked was read. Incidentally, the numerical value represents the penetration depth, and a larger numerical value indicates a softer texture.

The production methods of Examples 1 to 12 according to the invention all produced polyurethane foam sheets excellent in texture.

Meanwhile, in Comparative Examples 1, 2, 4, and 5, which all are modes using catalysts other than the amine catalyst (y1) specified by the invention, the texture was poor.

In Comparative Examples 3 and 6, which all are modes not using the amine catalyst (y1) specified by the invention, the texture was poor.

1. A method for producing a polyurethane foam sheet, comprising applying, in sheet form, a mixture obtained by mixing a moisture-curable polyurethane hot melt resin composition (X) containing a urethane prepolymer (i), which is a reaction product between a polyol (A) and a polyisocyanate (B), with a polyol composition (Y) onto a substrate, and bringing the mixture in the sheet form into contact with water vapor to moisture-foam the mixture, wherein
the polyol (A) contains:
a polytetramethylene glycol or polycarbonate polyol (a1); and
a polyol (a2) having a structure derived from an alkylene oxide adduct of bisphenol A, and
the polyol composition (Y) contains an amine catalyst (y1) having a foaming constant (Kw) of 10 or more.

2. The method for producing a polyurethane foam sheet according to claim 1, wherein the amine catalyst (y1) is a combination of 1,4-diazabicyclo[2.2.2]octane=triethylenediamine and another amine catalyst.

3. The method for producing a polyurethane foam sheet according to claim 1, wherein the polyol (a2) is a polyether polyol (a2-1) having a structure derived from an alkylene oxide adduct of bisphenol A and/or a polyether polyol (a2-2) having a structure derived from an alkylene oxide adduct of bisphenol A.

4. The method for producing a polyurethane foam sheet according to claim 1, wherein during the contact with water vapor, the temperature is less than 80° C., and the humidity is less than 95%.

5. A method for producing a synthetic leather having at least a substrate, an adhesive layer, and a skin layer, wherein the adhesive layer is obtainable by the method for producing a polyurethane foam sheet according to claim 1.

6. A method for producing a synthetic leather having at least a substrate, an adhesive layer, and a skin layer, wherein the adhesive layer is obtainable by the method for producing a polyurethane foam sheet according to claim 2.

7. A method for producing a synthetic leather having at least a substrate, an adhesive layer, and a skin layer, wherein the adhesive layer is obtainable by the method for producing a polyurethane foam sheet according to claim 3.

8. A method for producing a synthetic leather having at least a substrate, an adhesive layer, and a skin layer, wherein the adhesive layer is obtainable by the method for producing a polyurethane foam sheet according to claim 4.
